(19) United States
(12) Patent Application Publication
(10) Pub. No.: US 2023/0273234 A1
(43) Pub. Date: Aug. 31, 2023

(54) MECHANICAL ASSEMBLY FOR MEASURING ROTATION IN SHAFTS

(71) Applicant: ALTA TECNOLOGIA EN APLICACIÓN DE FLUIDOS S.A. DE C.V., San Felipe Hueyotlipan Puebla (MX)

(72) Inventor: Aaron VILLEGAS CUAUTLE, PUEBLA (MX)

(21) Appl. No.: 18/005,384

(22) PCT Filed: Jul. 13, 2021
(86) PCT No.: PCT/MX2021/050034

§ 371 Date: Jan. 13, 2023

(30) Foreign Application Priority Data
Jul. 13, 2020 (MX) MX/U/2020/000136

(51) Int. Cl. G01P 3/02

(52) U.S. Cl. CPC G01P 3/02

(57) ABSTRACT

The present invention relates to a mechanical assembly for measuring rpm of a rotating shaft in devices including rotating shaft. Said mechanical assembly comprises an rpm measuring device, which includes a rotating axis for the measurement, a base support which houses and keeps fixed thereto said rpm measuring device, a casing to which said support is fixed and which allows the passage of said rotating shaft, a first rotation drive pulley fixed to the rotating shaft of the rpm measuring device, a second rotation drive pulley fixed to the rotating shaft of the device to which the rpm measurement is to be conducted, the casing being connected to said device, and a belt operatively connected to the first and second drive pulleys, being aligned in the same level. This assembly is totally mechanical, lacking electrical and/or electronic elements, so the risk of generating sparks is not present. The assembly is useful in several industries, especially those in which flammable solvents are used, for example, automotive paint industry.

### TECHNICAL FIELD

The present description relates, in general, to an assembly adaptable to shafts or axis of devices having them, and more particularly, to an assembly for measuring the rotational speed on shafts of devices having them.

### BACKGROUND OF THE INVENTION

A wide range of devices with rotating shafts or axis are currently used in industry to perform the operations for which they are intended. Drilling, stirring, mixing-homogenizing, torque transmission activities and devices, among others, are some examples wherein rotating shafts are used.

It is convenient to know the angular velocity or revolutions per minute (rpm) of the rotating shafts in the devices to establish if the device is optimally performing in a given process. In some cases, like in the homogenization of liquid fluids, it is necessary to know the rpm value at which the shaft is rotating by the torque transmission of a stirring motor to know if a correct homogenization of the constituent elements of a fluid is being conducted. In other cases, for example, in the production of polyethylene, a stirring shaft rotating at an rpm value higher than a certain preset rpm value for the process may destroy the product, i.e., the expected amount of solid polyethylene will not be formed.

Some solutions proposed to measure rpm have been through electronics or by means of sophisticated control devices, such as PLC. These options, widely known, are regularly costly both in terms of purchasing and maintenance of them or repairing in case of failure, in addition to the time required to put them back into operation. In addition, these solutions can often give false measurements, i.e., erroneous rpm values, for example, for misadjustment or decalibration of the device having the shaft or the measuring electronic device. In other cases, the establishment of preset rpm in the device is relied on and a real measurement is not made on them or there is no way to make such a measurement in some devices, for example, in pneumatic stirrers.

In the industry of paints, more especially in automotive paints, a stirring control at certain rpm is required for the correct homogenization of solvents and solids which include pigments (color) and other particles such as flakes or beads which provide desired finishings. If the homogenization of these components is not done properly some parts of the paint will have different proportions of said components and therefore irregular finishings are obtained when the paint is applied on different areas of the object to be painted.

Therefore, the present invention is directed to a mechanical assembly which permits the measurement of rpm in devices including rotating shafts, which is adaptable to any type of rotating shaft, in particular, to rotating shafts in pneumatic devices and which does not depend on easily-damaged electronic parts as well as a simplicity for its application, repairing and for an accurate measurement of rpm in said rotating shafts and other desirable features which will be evident from the following detailed description of the invention.

### BRIEF DESCRIPTION OF THE INVENTION

An object of this invention is to provide a mechanical assembly for the measurement of rpm on shafts of devices having them.

Another object of this invention is to provide a mechanical assembly for the measurement of rpm on shafts of pneumatic devices, particularly stirrers or pneumatic stirring motors.

### BRIEF DESCRIPTION OF THE FIGURES

The attached Figures are incorporated and form part of the description in an illustrative manner and said Figures should not be considered as a limitation thereof.

FIG. 1 shows a perspective view of an embodiment and/or configuration of a mechanical assembly for the measurement of rpm in a pneumatic stirrer.

FIG. 2 shows a view of the embodiment and/or configuration of the mechanical assembly of FIG. 1 with the casing uncovered to allow the interior of the casing to be seen.

FIG. 3 shows a semi-exploded view of the embodiment and/or configuration of the mechanical assembly of FIG. 1.

FIG. 4 shows an exploded view of the mechanical assembly of FIG. 1.

### DETAILED DESCRIPTION OF THE INVENTION

This description refers, in a general way, to a mechanical assembly for measuring rpm on rotating shafts of devices having them, comprising a rpm measuring device which includes a rotating axis for the measurement, a support base which houses and keeps fixed thereto said rpm measuring device and which allows the passage of the rotating axis thereof, said support base being fixed to a casing which also allows the passage of said rotating axis. A first rotation drive pulley is fixed to the rotating axis of the rpm measuring device. The device to which the rpm measurement is to be conducted is evidently a device including a rotating shaft, in which a second rotation drive pulley is fixed to the rotating shaft of the device. The first and second drive pulleys are operatively connected to each other by a belt and both pulleys are aligned in the same level, i.e., aligned with each other. The casing is attached to the device to be measured, allowing the rotating shaft of said device to pass therethrough, so that it maintains a constant distance between the rotating shaft of the device and the rotating axis of the rpm measuring device to prevent the belt slackening and slipping off the pulleys. The first and second pulleys and the belt are located inside the casing. When the rotating shaft device is driven the rotating shaft drives a torque to the second pulley which in turn drives said torque to the first pulley via the belt and to the rotating axis of the rpm measuring device on which the measurement is made.

In one embodiment applicable in any other embodiment of the present invention, the rpm measuring device is an odometer widely known in the prior art so that its constitution and description should be understood by reference.

In one embodiment applicable in any other embodiment of this invention, the pulleys present a ratio of first pulley to second pulley diameters of 1:1. However other ratios may be used, provided that the necessary adjustments and considerations are made in the rpm measuring device. For example, if the range of measurement of the rpm measuring device falls outside of the known rpm range of the device, it is possible to use a pulley diameter ratio other than 1:1, i.e., 1:>1 or vice versa as required and the user will make the calculations to obtain the rpm value corresponding to such a pulley diameters ratio.

In one embodiment applicable to any other embodiment of the present invention, the pulleys are toothed pulleys in which case the belt should also be toothed.

The assembly of this invention may additionally have at least a belt tensioning element known in the prior art, for example, tension rollers, in order to keep the tension between the two pulleys and the belt. Said at least one belt tensioning element may be attached to the casing for tensioning close to the first pulley or to the second pulley, or close to both pulleys. Of course, said at least one tensioning element is located inside the casing.

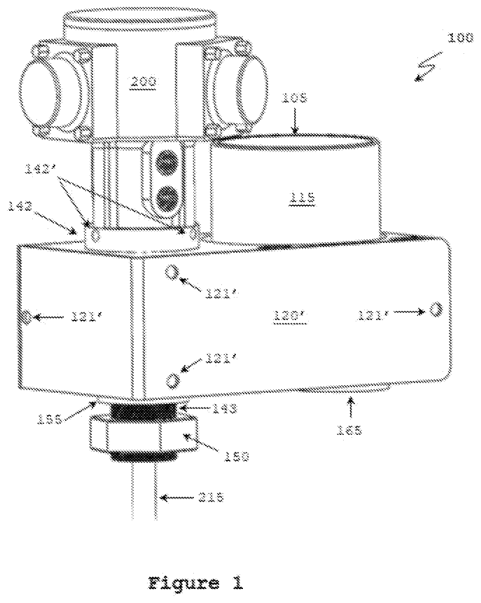

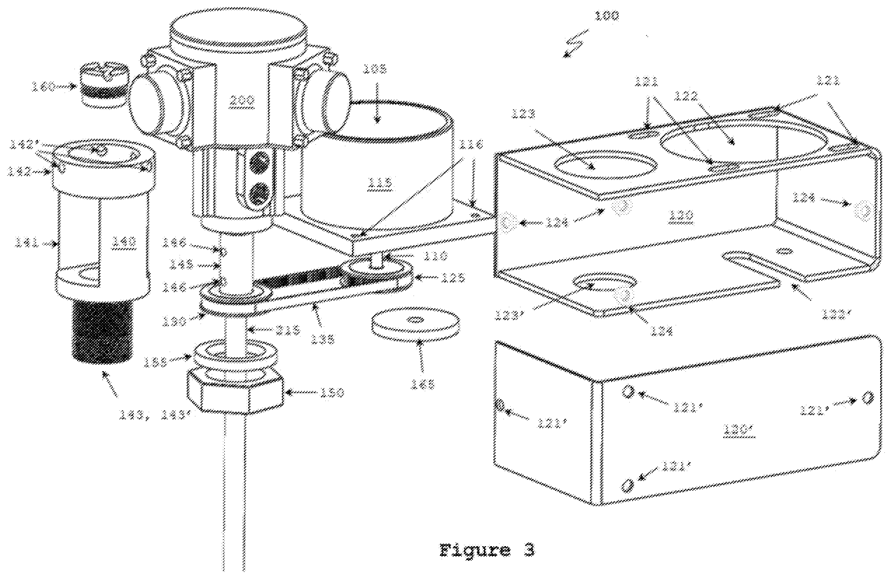

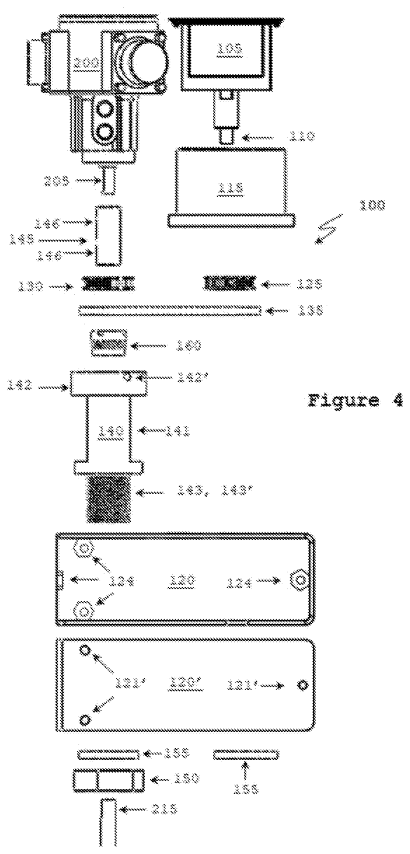

The device including a rotating shaft to which the rpm measurement is to be conducted, as mentioned above, can be any device that has a rotating shaft to perform its purpose. Some enunciative but not limiting examples of the device are pneumatic or electric stirrers for fluids, any type of motor, among others. Preferably, the mechanical assembly of the present invention is susceptible of being attached to the device including a rotating shaft and to a working surface wherein the device conducts its purpose as it is explained below in one embodiment of the present invention and an example thereof will be shown in the embodiment corresponding to FIGS. 1 to 4. For example, stirrers for fluid should be placed and attached on the lid of the container wherein the homogenization takes place, so as said lid is the working surface, in particular those focused to the homogenization of paints. Such attaching can be done by different means which may be part of the mechanical assembly of the present invention or known in the state of the art.

In one embodiment applicable in any other embodiment of the present invention, the mechanical assembly of the present invention further includes a connecting means capable of being attached to said device including a rotating shaft to the casing and to the working surface without interrupting the rotation of the rotating shaft of the device, the second pulley and the belt passage. Said connecting means may include different configurations useful for the present invention. In an illustrative but not limiting example, the connecting means is a jacket comprising open parts, recesses or windows allowing freely the rotation of the rotating shaft of the device, the second pulley and the passage of the belt through said jacket, an attaching section to the device including rotating shaft and a connecting section capable of being attached to the casing and to a working surface. The fastening and connecting sections may have configurations known in the art.

In order to avoid vibrations and cavitations between the casing and the components associated and/or housed therein of the mechanical assembly of the present invention and the device including a rotating shaft and the working surface when said device with rotating shaft is operatively active, in an embodiment applicable to any other embodiment of the present invention, the mechanical assembly may further include at least one seat support base outside of the casing which is arranged in different positions thereof and/or directly or indirectly associated to said device including rotating shaft.

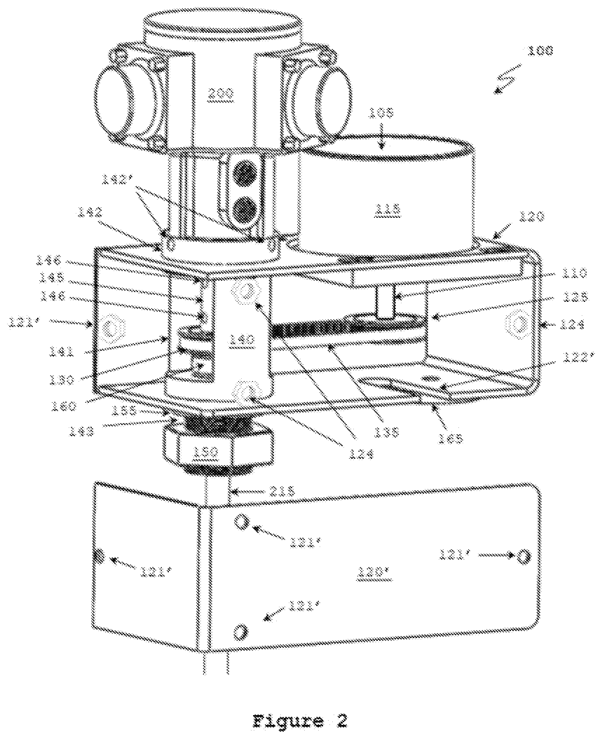

In a preferred embodiment, wherein its technical features are applicable in any other embodiment of the present invention and referring to at least one of FIGS. 1 to 4, a mechanical assembly 100 for measuring rpm on rotating shafts of devices having them which comprises an odometer 105 including a rotating axis 110 which is housed in and fixed to a support base 115 allowing the passage of the rotating axis 110 through thereof. The support base 115 has holes 116 through which bolts with respective nuts (not shown) pass to attach it to a casing 120 having holes 121 matching the holes 116 in the support base 115. The casing 120 further includes a first upper hole 122 through which the support base 115 passes therethrough and a lower slot 122′, a second upper hole 123 and lower hole 123′ which allow passage of the rotating shaft 205 of a pneumatic motor 200, and nuts 124 attached to the inside of the edge of the casing. A lid 120′ with holes 121′ matching the holes in the nuts 124 closes the inside of the casing 120 and are joined by bolts (not shown) which pass through the holes in the nuts 124 and the holes 121′ in the lid 120′. The rotating axis 110 is fixed to a first rotation drive toothed pulley 125. A bushing 145 with bores 146 and idlers (not shown) is attached to the rotating shaft 205 of the pneumatic motor, and a second toothed pulley 130 is attached to the bushing 145. Both pulleys 125, 130 have a 1:1 diameter ratio and are operatively connected to each other by a toothed belt 135, the pulleys 125, 130 being aligned in the same level. The first toothed pulley 125, the second toothed pulley 130, the toothed belt 135 and the bushing 145 are located inside the casing as can be seen more clearly in FIG. 2. Likewise, a jacket 140 comprising a section with windows 141 which allow the belt to pass through the same and is located inside the casing 120, a fastening section 142 with holes 142′ and idlers (not shown) by means of which the pneumatic motor 200 is fastened and which passes through the second upper hole 123 of the casing 120, and a connecting section 143 having an external thread 143′ and an internal thread (not shown) which passes through the lower hole 123′ and is located on the outside of the casing 120 which constitutes the connecting means enabling attachment to said pneumatic motor 200 to the casing 120 and to a work surface, for example, a container lid wherein the operation of the pneumatic motor on a fluid is required, such as paint or fabrication thereof. The external thread 143′ has the functionality both to attach to the casing 120 by means of a nut 150 and a first ring-shaped seating support base 155 and to attach said casing 120 to a work surface having an according threaded section. The inner thread (not shown), in turn, connects to a partially threaded bushing 160 between the second toothed pulley 130 and the jacket 140 on its inner side, through which the rotating shaft 205 passes. Additionally, a second ring-shaped seating support base 165 is positioned and fixed (means not shown; known in the art) in the lower slot 122′ on the outer side of the casing 120.

As will be seen, the rotating shaft 205 of the pneumatic motor 200 is also attached to a stirring rod 215 via bushing 145 with bores 146 and idlers (not shown).

Another advantage of the mechanical assembly of the present invention, in addition to those indicated above and those which will be evident from this description in any of its modalities, is that it is possible to monitoring the rpm values of a rotating shaft in a device including a rotating shaft without electrical and/or electronic elements which could generate sparks being very dangerous in cases where in volatile and flammable liquids take part in a process wherein such a device is required, since the risk of explosion is extremely high. An example of this is the mixing and homogenization of automotive paints, wherein flammable solvents are used for the preparation of such paints. Since the mechanical assembly of the present invention lacks of such electrical and/or electronic elements, the risk indicated for determining the rpm value of the device is not present.

It is clearly evident that the mechanical assembly of the present invention can be used in several industries, for example, in the varnish, food, environmental water restoration, chemical and biological processes wherein CSTR type or agitated batch type reactors are used, among others which will be clearly evident to a technician in the art.

Likewise, the mechanical rpm measuring assembly of the present invention complies with characteristics of explosion proof equipment, in accordance with the ATEX Directive arising and applicable in the European Union, as well as it is susceptible of obtaining the CE (Conformité Européenne) marking and the symbol “EX” to identify it as approved under the ATEX Directive.

While certain features of the invention have been illustrated and described herein, many modifications, substitutions, changes, combinations, and equivalents will occur to those with knowledge and experience in the art. The invention is described in detail with reference to some particular embodiments or configurations, but it should be understood that various other modifications can be made, as well as combinations thereof, and still be within the spirit and scope of the invention. It is to be understood, therefore, that the following claims are intended to cover all modifications and changes falling within the true spirit of the invention.

1. A mechanical assembly for rpm measurement of a rotating shaft of a device including a rotating shaft comprising:
a) a rpm measuring device which includes a rotating axis for measurement,
b) a support base that houses and keeps fixed therein said rpm measuring device allowing the passage of the rotating axis thereof,
c) a casing attached to the device with rotating shaft to which the rpm measurement is to be conducted and the support base is attached to the casing, said casing allowing the passage of both the rotating shaft of the device to which the rpm measurement is to be conducted and the rotating axis of the rpm measuring device,
d) a first rotation drive pulley fixed to the rotating shaft of the rpm measuring device,
e) a second rotation drive pulley fixed to the rotating shaft of the device to which the rpm measurement is to be conducted, and
f) a belt operatively connected to the first and second drive pulleys which are aligned in the same level, the first pulley, the second pulley and the belt are located inside the casing.

2. The mechanical assembly according to claim 1, wherein the rpm measuring device is an odometer.

3. The mechanical assembly according to claim 1, wherein the pulleys have a first pulley to second pulley diameter ratio of 1:1.

4. The mechanical assembly according to claim 1, wherein the pulleys exhibit a first pulley to second pulley diameter ratio of 1:>1 or vice versa.

5. The mechanical assembly according to claim 1, wherein the pulleys are toothed pulleys, and wherein the belt is toothed.

6. The mechanical assembly according to claim 1, wherein said mechanical assembly further comprises at least one belt tensioning element.

7. The mechanical assembly according to claim 1, wherein the device including a rotating shaft to which the rpm measurement is to be conducted is a pneumatic or electric fluid stirrer or motor.

8. The mechanical assembly according to claim 1, wherein said mechanical assembly further comprises a connecting means capable of being attached to said device including a rotating shaft, to the casing and to a working surface without interfering with the rotation of the rotating shaft thereof, the second pulley and the belt pitch.

9. The mechanical assembly according to claim 8, wherein the connecting means being a jacket comprising open parts, recesses, or windows, including an attaching section to said device including a rotating shaft and a connecting section to the casing and to a working surface.

10. The mechanical assembly according to claim 8, wherein said mechanical assembly further comprises at least one seating support base on the outside of the casing.

11. A mechanical assembly for measuring rpm of rotating shafts of rotating shaft devices comprising:
a) an odometer including a rotating axis,
b) a first toothed pulley fixed to the rotating axis of the odometer,
c) a support base for housing the odometer and allowing the passage of the rotating axis of said odometer, said support base has holes for the passage of bolts,
d) a casing comprising holes suitable for the passage of bolts matching the holes of the support base which is attached to the said case by means of bolts and nuts, a first upper hole allowing the passage of the support base, a lower slot, a second upper hole and a lower hole allowing the passage of the rotating shaft of a device including a rotating shaft which is a pneumatic motor and nuts attached to the inside of the edge of the casing,
e) a lid with holes, matching the holes in the casing, the lid with holes is attached to the housing by bolts passing through the holes in the nuts and the lid,
f) a second toothed pulley fixed to a bushing with idlers which is fixed to the rotating shaft of the pneumatic motor,
g) a toothed belt operatively connected to said first and second toothed pulleys, the first and second toothed pulleys having a ratio of diameters 1:1 and being aligned in the same level, the first toothed pulley, the second toothed pulley and the belt are located inside the casing,
h) a jacket comprising a section with windows 141 allowing the belt to pass thereof and located on the inside of the casing, a fixing section with holes and idlers through which it is fixed to the pneumatic motor which passes through the second upper hole of the casing, and a connection section which passes through the lower hole of the casing and is located on the outside thereof, said connecting section having an external thread for attachment to the casing by means of a nut and a first ring-shaped seating support and to a working surface having a corresponding threaded section, and an internal thread between the second toothed pulley and the inside of the jacket inside, which is connected to a partially threaded bushing, through which the rotating shaft of the pneumatic motor passes, and
i) a second ring-shaped seat support which is positioned and fixed in the lower slot of the casing on the outside thereof.

12. The mechanical assembly according to claim 11, wherein the rotating shaft of the pneumatic motor is connected to a stirring rod by means of the bushing with idlers.
